(19) United States
(12) Patent Application Publication
(10) Pub. No.: US 2018/0278032 A1
(43) Pub. Date: Sep. 27, 2018

(54) METHOD AND SYSTEM FOR REMOVING A BRAIDED SHIELD FROM ELECTRICAL CABLE

(71) Applicant: Frisimos Ltd., Ra'anana (IL)

(72) Inventors: Hanan Ben-Ron, Givataim (IL); Tal Pechter, Ramat Hasharon (IL)

(73) Assignee: Frisimos Ltd., Ra'anana (IL)

(21) Appl. No.: 15/756,424

(22) PCT Filed: Aug. 7, 2016
(86) PCT No.: PCT/IL2016/050861

§ 371 Date: Feb. 28, 2018

Related U.S. Application Data
(60) Provisional application No. 62/212,602, filed on Sep. 1, 2015.

(51) Int. Cl. H02G 1/12; B23K 26/351; B23K 26/03; B23K 26/0622; B23K 26/38; B23K 26/40; B23K 26/06

(52) U.S. Cl. CPC H02G 1/128; B23K 26/351; B23K 26/032; B23K 26/0624; B23K 2201/32; B23K 26/40; B23K 26/0626; H02G 1/1282; H02G 1/1297; B23K 26/38

(57) ABSTRACT

Disclosed is a method and apparatus for automated removal of a segment of a braided metal shield from an electric cable. A segment of a braided metal shield protruding from a holder is pulled back over a heat absorbing ring. The ring is inserted over the braided metal shield. Laser radiation of sufficient power is applied to the segment of the braided metal shield located over the ring to cut the braided metal shield located over the ring.

### TECHNICAL FIELD

The present disclosure generally relates to electrical cable and connector industry, and in particular to a system and method for removing braided metal shielding from electrical wires and/or cables.

### BACKGROUND ART

Different electrical and electronic equipment and their devices communicate between them through physical connectors and cables. Each device and/or apparatus may have specific connectivity requirements. Connectivity requirements could relate to physical connectivity between devices and to the communication protocol. Physical connectivity requirements could include a range of amplitude of current and/or voltage, Electromagnetic Interference (EMI) protection and others. A cable is most frequently used to connect between different electric and electronic devices.

The cable is usually one or more wires running side by side. The wires can be bonded, twisted, or braided together to form a single assembly. Every current-carrying conductor, including a cable, radiates an electromagnetic field. Likewise, any conductor or cable will pick up electromagnetic energy from any existing around electromagnetic field. This causes losses of transmitted energy and adversely affects electronic equipment or devices of the same equipment, since the noise picked-up is masking the desired signal being carried by the cable.

There are particular cable designs that minimize EMI pickup and transmission. The main design techniques include electromagnetic cable shielding, coaxial cable geometry, and twisted-pair cable geometry. Shielding makes use of the electrical principle of the Faraday cage. The cable is encased for its entire length in a metal foil or a metal wire mesh (shield). The metal could be such as aluminum or copper.

Coaxial cable design reduces electromagnetic transmission and pickup. In coaxial cable design the current conductors are surrounded by a tubular current conducting metal shield which could be a metal foil or a mesh. The foil or mesh shield has a circular cross section with the electric current conductors located at its center. This causes a symmetric magnetic field between the shield and the conductors which does not induce any voltage or current on the conductors located at the center. To reduce or prevent electromagnetic interference, other types of cables could also include an electromagnetic shield.

Cable assembly is a process that includes; combining individual wires or pair of wires and a metal foil shield into an electrical cable. Connectors terminate one or both ends of the cable. Individual wires are stripped from the isolation and soldered to connector pins. If the cable contains a metal foil shield, the shield has to be at least partially removed to allow unobstructed access to the individual wires and pins.

Patent Cooperation Treaty application PCT/IL2015/00009 to the same assignee describes a method and apparatus to remove a metal foil shield by using laser radiation to ablate a shallow groove in the metal foil, induce stress in the groove and to tear off a segment of the shield adjacent to the ablated region.

Braided shielding presents a different challenge since the thickness of the metal braid which is placed over a cable core or an insulated conductor is larger than the metal foil thickness. The braided shield is made of individual wires/strands or groups of tinned or bare copper or aluminum strands. Usually, one group is woven in a clockwise direction and interwoven with another group in a counterclockwise direction. This criss cross lattice of shielding conductor strands is more difficult to make, although braided shields offer a number of advantages over metal foil shields. The shield coverage can be varied from 50% to nearly 100% by changing the angle, the number of strands and the rate at which they are applied. Braided shield does not change the coverage when the cable is flexed or bent, unlike other types of shields. This is important in shielding the signal from RFI. The RF-shielding superiority is further enhanced by very low inductance, causing the braid to present a low transfer impedance to high frequencies. This is important when the shield is supposed to be conducting interference harmlessly to ground. Drawbacks of the braid shield include restricted flexibility, high manufacturing costs because of the relatively slow speed at which the shield-braiding machinery works, and the laborious strands picking and pigtailing operations required to solder them to connectors or circuit parts.

### Glossary

As used in the current disclosure the term “Foil Shield Cable” is a cable that includes a shield of thin foil, for example aluminum foil, with almost 100% coverage of the cable. Aluminum foil thickness is about 0.4 mil (10 μm) to 2.0 mil (50 micron).

As used in the current disclosure the term braided shield means a shield that consists of groups of tinned or bare copper or aluminum strands, one set woven in a clockwise direction and interwoven with another set in a counterclockwise direction. The diameter of strands could be 2.0 mil (50 micron) to 12.0 mil (300 micron). Braid shields are generally bulkier and heavier than other shields and, in some cases, harder to terminate because the braid must be combed out and pigtailed.

### SUMMARY

Disclosed is a method and apparatus for automated removal of a segment of a braided metal shield from an electric cable. The method includes insertion of a segment of a braided metal shield into a ring made of ceramic or low heat conducting metal. The braided metal shield of the cable is handled to cover the ring and laser radiation is operated and directed to cut the braided metal shield located over the ring. The ring absorbs excessive heat generated by the laser radiation cutting process and prevents damage to cable isolation.

In some examples a video camera could be used to monitor the process and/or provide information to a processor running an image processing algorithm. The algorithm, among others could be used to amend the laser power, pulse repetition rate, pulse width, and scan speed to maintain a high quality cut without causing thermal damage to the isolation.

### BRIEF DESCRIPTION OF THE DRAWINGS

FIGS. 1A and 1B are examples illustrating structure of a braided metal shield cable;

FIGS. 2A-2E are schematic illustrations of an example of a process for removing a braided metal shield in an electrical cable;

FIGS. 3A-3D are schematic illustration of an additional example of a process for removing a braided metal shield in an electrical cable;

FIGS. 4A-4C are schematic illustrations of an additional example of a process for removing a braided metal shield in an electrical cable; and

FIG. 5 is a schematic illustration of an apparatus for removing a braided metal shield according to an example.

### DESCRIPTION

The advantages of the braided shields are somehow diminished by their high manufacturing costs, caused by relatively slow speed at which the shield-braiding machinery works, the laborious picking of each individual wire or strand when preparing for termination to jacks, connectors or circuit parts since the strands must be separated manually first and then soldered to connectors. Manual cut of a large number of strands or individual wires causes the remaining part of the braided metal shield to have different length that further complicates soldering to connectors or circuit parts.

The method of foil shield cutting and removal disclosed in PCT application IL2015/00009 does not apply to braid metal shielding. The groups of woven in a clockwise direction interwoven with another groups in a counterclockwise direction overlap and to be cut require higher laser power. Such level of laser power would melt any polymeric isolation even before the braided shield is cut. Hence a different method is required to cut and remove braided metal shielding from an electrical cable. The method needs to provide enough laser radiation to affect the cutting of the braided shield without negatively affecting the jacket, isolation or electrical wires.

The present document discloses a method and apparatus for automated removal of a braided metal shield from an electrical cable.

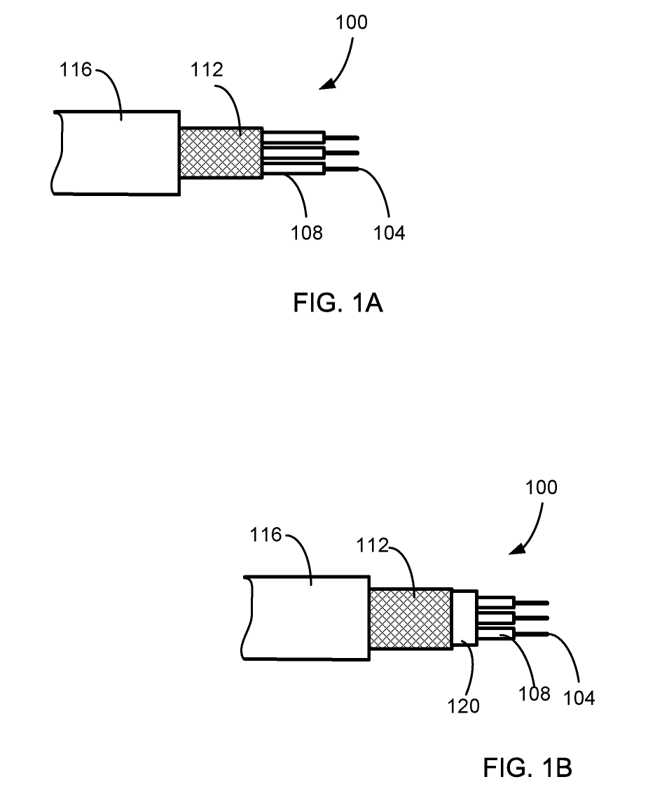

FIG. 1A is an example illustrating structure of a braided shield cable. Cable 100 includes one or more inner conductors 104 surrounded by an insulating layer 108. A tubular braided shield 112, which consists of sets of tinned or silver plated or bare copper or aluminum strands. One set woven in a clockwise direction and interwoven with another set in a counterclockwise direction. The braided metal shield 112 provides shielding of electromagnetic radiation, and prevents signals from the electrical conducting wires 104 to be transmitted outside the cable, as well as preventing external signals to create noise on the electrical conducting wires 104. A jacket 116 typically made from Fluorinated Ethylene Polypropylene (PET) surrounds the braided shield. Other cable structures that could include multiple braided shields and multiple insulating layers 108 and 120 (FIG. 1B) exist. Jacket 116 which is used to electrically isolate the electrical cable, can be made from plastic, polymers, or rubber. The thickness of the braided metal sheet could be from 2.0 mill to 12.0 mil.

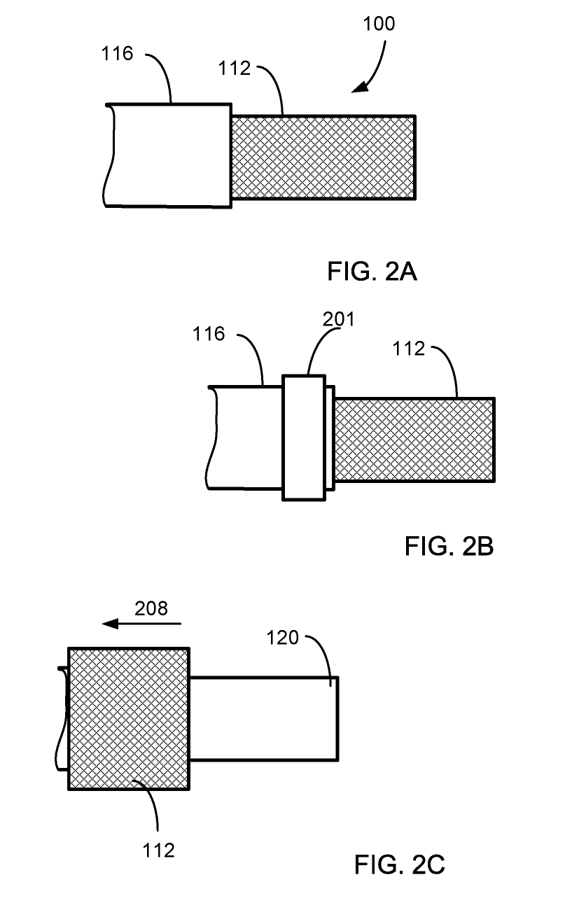

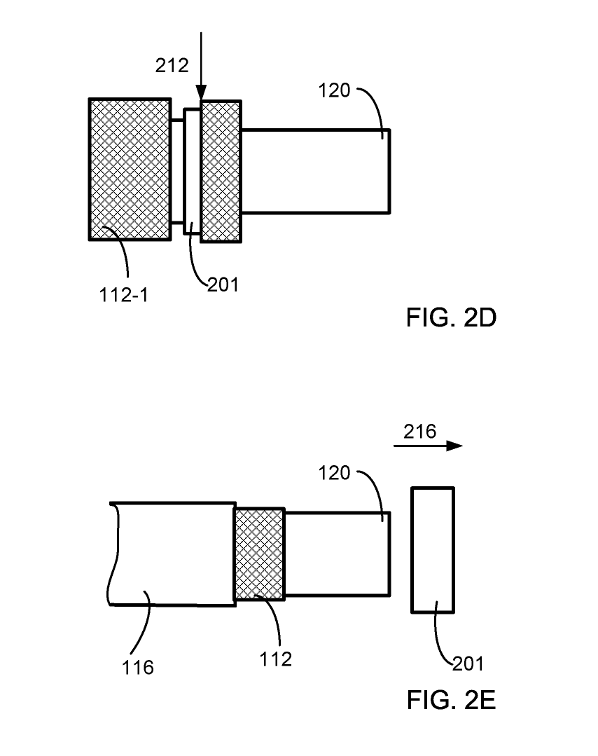

FIG. 2 is a schematic illustration of an example of a process and apparatus for removing a braided metal shield in an electrical cable. The process starts with delivery of an electrical cable 100 (FIG. 2A) where a segment of jacket 116 has been removed by different known methods to expose the braided metal shield 112. The process includes five steps:

FIG. 2B is an example of a process stage where a ring 201 held by a chuck, which is not shown in FIG. 2 is inserted over the electrical cable 100 jacket (116). The ring (201) could be made of metal or ceramic and is used to absorb the laser radiation as a laser beam cuts the braided metal shield, and to prevent thermal damage to jacket (116), electrical isolation (108 or 120) or electrical wires (104).

FIG. 2C is an example of a process where the braided metal shield 112 is pulled back by another chuck (as shown by arrow 208) with inner diameter exceeding the outer diameter of the ring (201). In some examples the chuck could be configured to stretch and expand the braided shield diameter to a size sufficient to be pulled over the ring (201).

At the next stage, (FIG. 2D) laser radiation schematically shown by arrow 212 and provided by a laser cuts the braided metal shield (112). Such laser could be a diode laser or a Nd:YAG laser. In one example, the laser is mounted in a system composed of mirrors, lenses and a rotating assembly as it is disclosed in PCT application IL2015/00009 to the same assignee or by a rotating mirror assembly, whereby the system provides a laser beam scanning the circumference or perimeter of the electrical cable and cutting the braided metal shield along the scan line. The cut results in a cut segment of the braided metal shield (112-1) which is discarded by an appropriate mechanical or vacuum chuck or by blowing gas or air over the portion of the segment of braided shield 112 to be discarded. In some examples the cut segment of the braided metal shield could be removed by a chuck with fingers possessing high friction. FIG. 2E illustrates a stage in the process where the ring (201) is pulled back as shown by arrow 216 from the electrical cable, and the remaining (uncut) portion of braided metal shield (112) returns to the initial position and now partially covers the isolation (108 or 120).

Examples of material for the ring (201) include: low heat conducting metals such as Nickel, or ceramic materials. In one example the ring thickness is at least 0.5 mm. In another example the ring width is at least 5.0 mm.

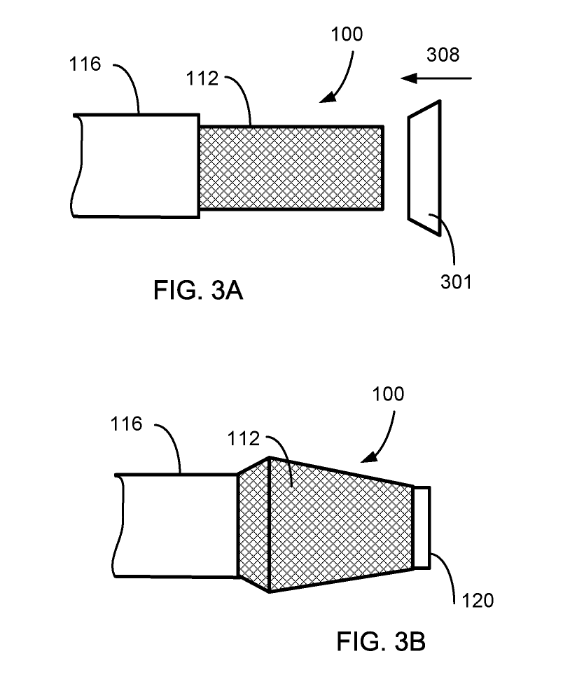

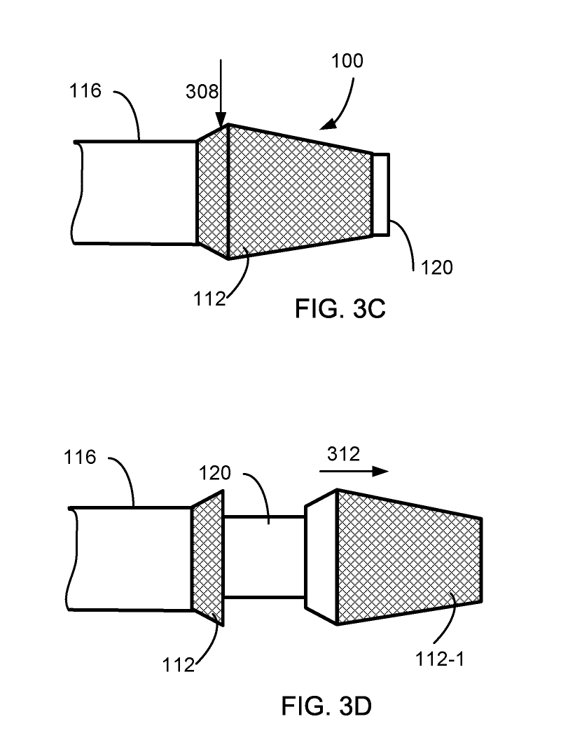

FIG. 3 is a schematic illustration of another example of a process and apparatus for removing a braided metal shield in an electrical cable. The process starts with an electrical cable where a part of the jacket (116) has been removed to expose the braided metal shield (112).

FIG. 3A and FIG. 3B are another examples of a braided shield removal process where cylindrical ring 201 has been replaced by a conic ring (301), Conic ring 301 is inserted between the braided metal shield (112) and the isolation (108 or 120). The ring is inserted with a chuck which is not shown in the drawing. The ring is used to absorb the laser radiation as a laser cuts the braided metal shield 212, and to prevent thermal damage to the jacket (116), electrical isolation (108 or 120) or electrical wires (104 in FIG. 1). The chuck or the conic ring (301) could be configured to expand the braid diameter such as to accept the ring and be stretched over the ring.

FIG. 3C illustrates a stage of the braided metal shield removal process, where the braided metal shield is cut over conic ring 301 with a radiation schematically shown by arrow 308 emitted by a laser. In one example, the laser is mounted in a system composed of mirrors, lens and a rotating assembly or rotating mirror assembly, whereby the system provides a laser beam scanning the circumference or perimeter of the electrical cable and cutting the braided metal shield along the scan line. The laser cut results in a portion of the braided metal shield (112-1). Movement of conic ring 301 in the direction indicated by arrow 312 (FIG. 3D) removes portion 112-1 of the braided metal shield 112 from the cable and the uncut or remaining portion of the braided metal shield 112 now partially covers the isolation (108 or 120). The removed portion of the braided metal shield 112 is discarded (FIG. 3D) by an appropriate mechanical or vacuum chuck or by blowing gas over the portion to be discarded (112-1).

Examples of material for the ring (301) include; low heat conducting metals such as Nickel, or ceramic materials. In one example the ring thickness is at least 0.5 mm. In another example the ring width is at least 7.0 mm.

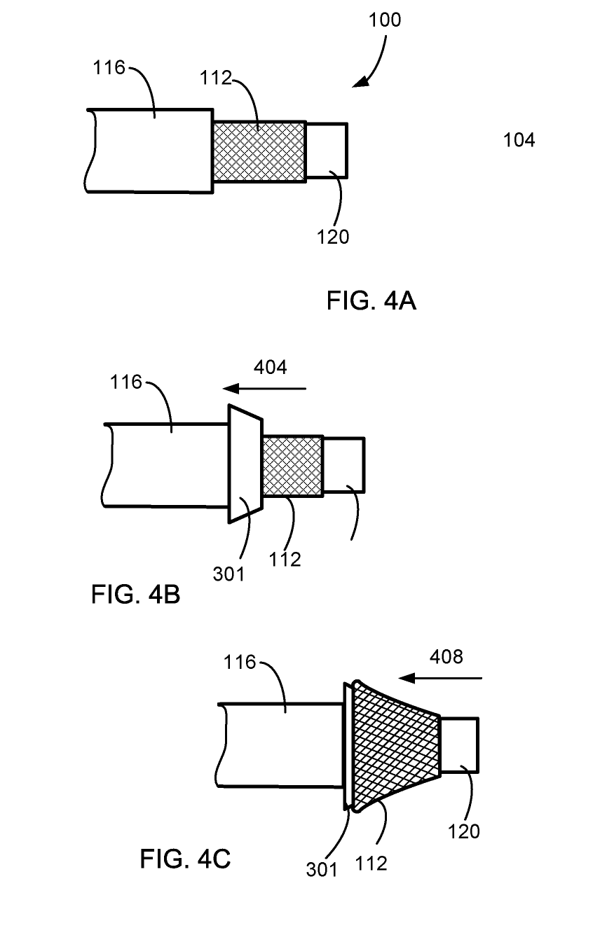

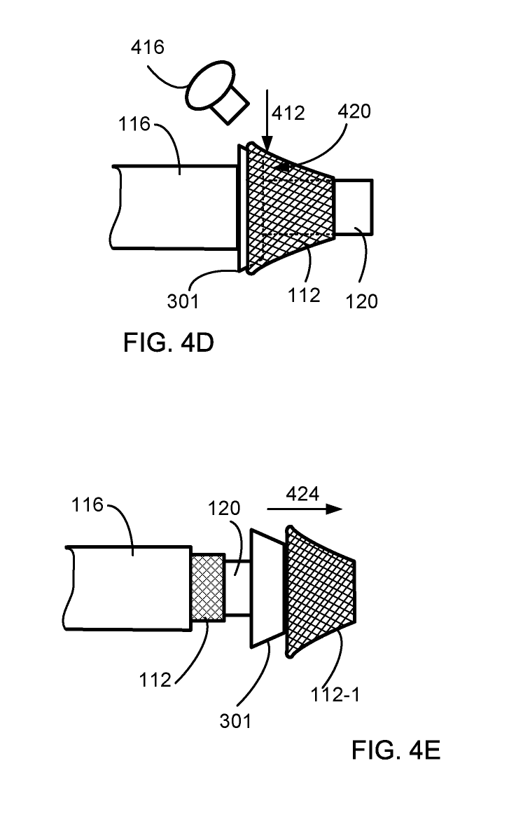

FIG. 4 is a schematic illustration of an additional example of a process for removing a braided metal shield from an electrical cable. The process starts with delivery of an electrical cable 100 (FIG. 4A) where a segment of jacket 116 has been removed by different known methods to expose the braided metal shield 112.

FIG. 4B illustrates a stage where any one of rings 201 or 301 as shown by arrow 404 is mounted over the braided metal shield 112 by sliding the ring 201 or 301 until jacket 116 stops ring 201 or 301. Next (FIG. 4C), as illustrated by arrow 408, braided metal shield 112 is pushed over ring 301. The amount of braided metal shield 112 pushed over ring 301 determines the length of the remaining on the cable part of the braided metal shield.

FIG. 4D illustrates braided shield 112 cutting stage. Laser radiation as schematically illustrated by arrow 416 is directed to braid metal shield 112 overlaying ring 301. Since there is a gap 420 between braid metal shield 112 and isolation 120 that would reduce the heat transfer to isolation 120, laser radiation 412 could be directed to a segment of the braid metal shield not overlaying ring 301. A video camera 416 is mounted to image the braid metal shield cutting process. An algorithm could be used to analyze the cut process and amend the laser power, pulse repetition rate, pulse width, and scan speed to maintain a high quality cut without causing thermal damage to the isolation (108), electrical wire (104) or jacket (116). The cut results in a portion of the braided metal shield (112-1) which is removed by sliding back ring 301 as shown by arrow and then discarded by an appropriate mechanical or vacuum chuck or by blowing gas over the portion to be discarded (112-1);

The laser is mounted in a system composed of mirrors, lens and a rotating assembly or rotating mirror assembly, whereby the system provides a laser beam scanning the circumference of the electrical cable and cutting the braided metal shield along the scan line

FIG. 4E is an example of a process where the cut portion of the braided metal shield (103) is pulled and discarded and the uncut portion now partially covers the isolation (105).

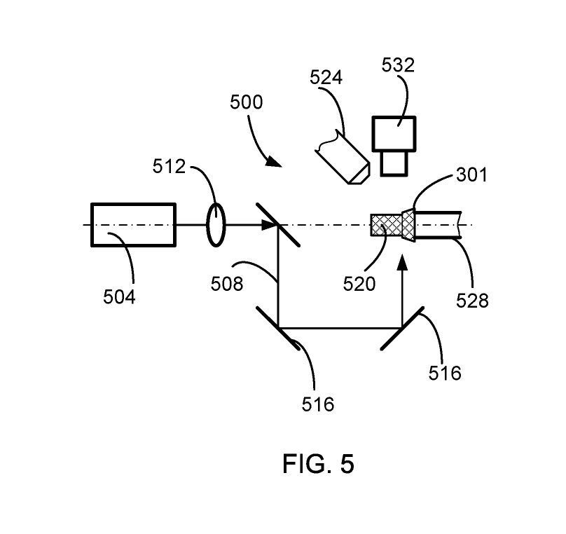

FIG. 5 is a schematic illustration of an example of a braided metal shield removal system. Braided metal shield removal system 500 includes a laser 504 configured to provide a laser radiation beam 508 and an optical system that includes a lens 512 and a number of folding mirrors 516. Laser 504 could be such as a q-switched Pulse/CW fiber laser, commercially available from Optisiv Ltd. Kibbutz Einat 48805, Israel. (Fiber laser is a laser in which the active gain medium is an optical fiber doped with rare-earth elements such as erbium, ytterbium, neodymium, dysprosium, praseodymium, and thulium.) The fiber laser could be operated either in Pulse or Continuous Wave (CVV) mode. Use of a fiber laser has some advantages over solid state lasers such as Nd-YAG, and gas lasers such as CO₂. Fiber laser has a compact size, low cost, simple maintenance, and long life time, all of these are important for industrial use. The fiber laser in pulse mode generates pulses with duration from 300 psec to 500 nsec and peak power of 1 kw to 500 kw. The high peak power supports easy braided metal shield 520 over ring 301 cut. A nozzle 524 is configured to direct a stream of air to dispose the removed segment or braided metal shield 520. A gripper (not shown) could be adapted to howl and advance braided metal shield cable 528. A video camera 532 could be configured to image the area of braided metal shield 520 cut. The image provided by the camera could be communicated to a processor for monitoring the braided metal shield cut and removal process. Use of a video camera 532 supports monitoring and inspection of the application of the laser radiation and control of the laser radiation and cut parameters to prevent thermal damage to the jacket, and isolation or electrical wires.

To sum, this document describes a number of examples of method and related apparatus to remove a braided metal shield 112 from an electrical cable.

The described method and apparatus use laser radiation and a heat absorbing ring to produce a clean cut at different braided metal shield thicknesses. It is clear that in the implementation of the apparatus and method many modification could be made to the system that carries out the described process. It should be considered that all modifications and alterations of the system and method are falling within the scope of the appended claims.

What is claimed is:

1. A method for removing a segment of a braided metal shield from an electric cable comprising:
inserting an electrical cable into a holder such that a segment of a braided metal shield to be removed protrudes from the holder;
inserting a ring over braided metal shield segment protruding from the holder;
pulling back over the ring the segment of a braided metal shield protruding from the holder;
applying laser radiation of sufficient power to cut the braided metal shield located over the ring; and
removing the ring and discarding a cut segment of the braided metal shield.

2. The method according to claim 1 wherein pulling back over the ring the segment of a braided metal shield protruding from the holder is performed by a chuck with inner diameter exceeding outer diameter of the ring.

3. The method according to claim 1 wherein removing the cut segment of the braided metal shield is performed by a chuck with fingers possessing high friction.

4. The method according to claim 1 wherein removing the ring restores initial location of the remaining part of the cut segment of the braided metal shield.

5. The method according to claim 1 wherein the laser radiation power is 1.0 W to 500 W.

6. The method according to claim 1 where the ring is composed of one of a group of materials consisting of metal and ceramics.

7. The method according to claim 1 where the ring has a thickness of at least 0.5 mm.

8. The method according to claim 1 where the ring has a width of at least 5.0 mm.

9. A method for removing a portion of a braided metal shield from an electric cable comprising:
inserting an electrical cable into a holder such that a segment of a braided metal shield to be removed protrudes from the holder;
inserting a conic ring between cable isolation and braided metal shield segment protruding from the holder;
applying laser radiation of sufficient power to cut a portion of the braided metal shield located over the conic ring; and
removing the conic ring and discarding a cut portion of the segment of the braided metal shield.

10. The method according to claim 9 wherein inserting a conic ring includes expanding the braided metal shield diameter to accept the conic ring and be stretched over the conic ring.

11. The method according to claim 9 wherein removing the conic ring removes the cut-off segment of a braided metal shield.

12. The method according to claim 9 wherein removing the cut portion of the segment of the braided metal shield is performed by a chuck holding the conic ring.

13. The method according to claim 9 wherein removing the ring restores initial location of the remaining part of a cut segment of the braided metal shield.

14. The method according to claim 9 wherein the laser radiation power is 1.0 W to 500 W.

15. The method according to claim 9 where the conic ring is composed of one of a group of materials consisting of metal and ceramics.

16. The method according to claim 9 where the conic ring has a thickness of at least 0.5 mm.

17. The method according to claim 9 where the conic ring has a width of at least 7.0 mm.

19. A method for removing a portion of a braided metal shield from an electric cable composed of a jacket, braided metal shield, isolation, and metal wires wherein said method is comprising:
inserting an electrical cable into a holder such that the segment of a braided metal shield to be removed protrudes from the holder;
applying laser radiation to cut a portion of the braided metal shield over a conic ring;
wherein a video camera inspect application of the laser radiation and controls the laser radiation and cut parameters to prevent thermal damage to the jacket, isolation or electrical wires; and
discarding a cut portion of the braided metal shield.

20. The method according to claim 19 wherein applying laser radiation to cut a portion of the braided metal shield without support by the conic ring.

21. An apparatus for removing braided metal shield from a cable comprising:
at least one holder configured to hold the cable;
a chuck configured to pick up a ring and deliver it over a braided metal shield of a cable;
a laser configured to provide a laser beam of sufficient laser power to cut at least individual strands of a braided metal shield;
a rotating mirror assembly configured to scan the laser beam across perimeter of a braided metal shield.
